(19) United States
(12) Patent Application Publication
(10) Pub. No.: US 2007/0224103 A1
(43) Pub. Date: Sep. 27, 2007

(54) Supercritical Treatment Method and Apparatus to be Used in the Same

(76) Inventor: Takashi Shimizu, Tsukuba-shi (JP)

Correspondence Address: BIRCH STEWART KOLASCH & BIRCH, PO BOX 747, FALLS CHURCH, VA, 22040-0747, US

(21) Appl. No.: 10/594,267

(22) PCT Filed: Mar. 25, 2005
(86) PCT No.: PCT/JP05/05535

§ 371 Date: Sep. 26, 2006

(30) Foreign Application Priority Data
Mar. 26, 2004 (JP) 2004-093691

(51) Int. Cl. C01B 31/20; B01J 3/00; C01B 7/19

(52) U.S. Cl. 423/437.1; 422/242; 423/462

(57) ABSTRACT

[Problem]An object of the present invention is to provide a method of continuously feeding a treating substance, as a supercritical solution fluid, into a pressurized reaction system. Another object of the present invention is to provide a supercritical fluid treatment apparatus that ensures consistent treatment through continuous feeding of such a supercritical solution fluid into a pressurized reaction system. [Means to Solve]The aforesaid objects can be achieved by dissolving an organic substance in a fluorine compound in a liquid state at room temperature and under normal pressure to prepare a solution, and introducing the solution into a supercritical fluid, thereby treating a substrate under a supercritical condition.

### TECHNICAL FIELD

The present invention relates to a method of treating a substrate with a solution prepared by dissolving a solid organic substance as a raw material in a fluid in a supercritical state inside a high-pressure vessel; or a method of forming a coating on a substrate with the solution; or a method of producing solid particulates from the solution, respectively, under a supercritical condition; and the present invention also relates to a critical treatment apparatus to be used in the method.

### BACKGROUND ART

In recent years, techniques of using supercritical fluids for micro-granulating substances; embedding in microstructures; coating on fibrous materials; coating on surfaces of fine particles; cleaning of silicon microstructures; drying of sintering stock; depositing a thin film at high step coverage, and so on, have been developed at a feverish pitch.

However, when substances were dissolved, e.g. in a supercritical fluid of carbon dioxide, and then a wide variety of substrates (e.g. a photo lithographically processed to be coated, catalyst-carrying fibrous glass, etc.) were treated with the supercritical fluid in which the substances were dissolved (hereinafter referred to as supercritical solution fluids), it was difficult to replenish the supercritical fluids with the substances in amounts commensurate with the amounts consumed during the treatment by dissolving them in the supercritical fluids.

In the usual case, therefore, a supercritical solution fluid was prepared by dissolving a solid substance in a treatment vessel whenever treatment was carried out. Alternatively, a supercritical solution fluid was prepared in a dissolution tank independent of a treatment vessel, and introduced into the treatment vessel whenever the treatment was carried out. Accordingly, there was a problem that the concentration of the dissolved substance decreased continuously with progress of consumption of the supercritical solution fluid. However, concentrations below a designated level brought about problems in the treatment itself, such that the supercritical solution fluid had to be prepared freshly, and there were limitations on how long the supercritical treatment was performed continuously.

From a viewpoint of the apparatus also, there was difficulty in feeding a solid raw material as a supercritical solution fluid into a vessel. For instance, although it is easy to introduce a massive solid substance into a vessel, a long time is required for dissolution in a supercritical fluid, because of its small surface area. Therefore, a long time is needed for preparation of a supercritical solution fluid having the required concentration, and therefore it is not easy to quantitatively feed the supercritical solution fluid so as to match the intended treatment or reaction. In the case of a powdery solid substance, on the other hand, the time required to dissolve it in a supercritical fluid is reduced dramatically, but there were problems caused by the apparatus, such that inconsistency in the feeding amount and apparatus failures happened frequently were caused by rising-up of a powdery solid at the time of introduction into a vessel, an increase in solids left behind in an introduction mechanism of the apparatus, and clogging in filters.

As an example of solutions to the aforesaid problems, non-patent Document 1 describes a method of dissolving an organometallic copper Cu(II)(β-diketonate)₂ in supercritical carbon dioxide (CO₂), by dissolving the Cu(II)(β-diketonate)₂ in alcohol prior to dissolution in the supercritical carbon dioxide, and then feeding the alcohol solution as raw material. However, the alcohol described in non-patent Document 1 is a general alcohol, such as methanol, 1-propanol, 2-propanol, 1-butanol or 2-butanol, and these alcohol compounds have safety problems, such as flammability and ignitability. Further, since an advantage, in many instances of supercritical treatment using supercritical carbon dioxide as in non-patent Document 1, is that, even though no organic solvent is generally used, treatment equivalent to cases using organic solvents can be performed, the method of dissolving a solid raw material by use of alcohol as a solvent has a problem of impairing the advantage attributable to not using organic solvents, and so on.

In addition, non-patent Document 1 does not describe a specific way to feed the solution of raw material into a supercritical fluid in a high-pressure state after the raw material is dissolved in alcohol, so the apparatus problem is not solved yet.
Non-patent Document 1: Microelectronic Engineering, 64, (2002), p. 53-61

### DISCLOSURE OF INVENTION

### Problem which the Invention is to Solve

According to the above, an object of the present invention is to provide a method of continuously feeding a treating substance as a supercritical solution fluid into a pressurized reaction system in a supercritical state.

Another object of the present invention is to provide a supercritical fluid treatment apparatus that ensures consistent treatment by continuously feeding the aforesaid supercritical solution fluid into a pressurized reaction system.

### Means to Solve the Problem

The inventor, intensively studying to solve the foregoing problems, found that the problems can be solved by feeding a supercritical solution fluid, prepared by dissolving a solid organic substance as raw material in a stable fluorinated compound, as a solvent, in a liquid state at room temperature and under normal pressure, into a reaction system. In addition, I found that an apparatus for continuously feeding an organic substance as raw material into a supercritical fluid with efficiently and safety, can be newly structured by adopting the method of using the aforesaid supercritical solution fluid. The present invention has been made based on these finding.

More specifically, the present invention provides a method that includes preparing a solution by dissolving, in a fluorinated compound, an organic raw material (e.g. a organic metal) in a solid state at room temperature and under normal pressure; introducing the solution into a fluid maintained in a supercritical state by a pressure of 1 MPa or above; and treating a substance with the solution under high pressure.

Further, the present invention provides a method that includes preparing a solution by dissolving, in a fluorinated compound, an organic raw material in a solid state at room temperature and under normal pressure; introducing the solution and a reactant capable of reacting with the organic raw material but incapable of reacting with the fluorinated compound, into a fluid maintained in a supercritical state by a pressure of 1 MPa or above; causing reaction of the solution and the reactant in the fluid; and coating a substrate with products of the reaction.

Further, the present invention provides a method that includes preparing a solution by dissolving, in a fluorinated compound, an organic raw material in a solid state at room temperature and under normal pressure; introducing the solution and a reactant capable of reacting with the organic raw material but incapable of reacting with the fluorinated compound, into a fluid maintained in a supercritical state by a pressure of 1 MPa or above; causing reaction of the solution and the reactant in the fluid; and making fine particles by the reaction.

In addition, the present invention provides a method that includes preparing a solution by dissolving, in a fluorinated compound, an organic raw material in a solid state at room temperature and under normal pressure; introducing the solution and a reactant capable of reacting with the organic raw material but incapable of reacting with the fluorinated compound, into a fluid maintained in a supercritical state by a pressure of 1 MPa or above; causing reaction of the solution and the reactant in the fluid; and filling micro-voids with products of the reaction.

Further, the present invention provides a novel apparatus that substantiates the aforesaid thin-film formation method, the fine-particle making method, and the micro-voids filling method. More specifically, the invention provides the supercritical treatment apparatus characterized by having a sealable raw material vessel, into which a solution, prepared by dissolving at least one organic raw material in a fluorinated compound, is introduced under atmospheric pressure; a high-pressure vessel in which a supercritical fluid is stored; a solution-feeding pump for pressurizing the solution and introducing the pressurized solution into the supercritical fluid-stored vessel; and a mechanism to send out the solution from the sealable raw material vessel to the solution-feeding pump, through application of pressure, and causing reaction of the solution in the high-pressure vessel or a reaction tank, and coating a substrate with solid products of the reaction.

In addition, the invention provides a supercritical treatment apparatus characterized by having a sealable raw material vessel, into which a solution, prepared by dissolving at least one organic raw material in a fluorocarbon compound, is introduced under atmospheric pressure; a high-pressure vessel in which a supercritical fluid is stored; a solution-feeding pump for pressurizing the solution and introducing the pressurized solution into the supercritical fluid-stored vessel; and a mechanism to send out the solution from the sealable raw material vessel to the solution-feeding pump, through application of pressure, and making the organic raw material undergo reaction in the high-pressure vessel or a reaction tank to obtain solid fine particles of reaction products.

### Effect of Invention

In the present invention, a solution is prepared by dissolving an organic raw material in a fluorocarbon compound, and this solution makes it possible to replenish a high-pressure vessel with the raw material without disturbing a supercritical state, or without bringing about changes in pressure and temperature inside the high-pressure vessel. Therefore, the applications of the invention in an open system or a high-pressure treatment in which the raw material concentration in supercritical CO₂ varies continuously, such as high-pressure treatment for deposition of a thin film on a substrate, making of particulates, or embedding of a reaction product in a substrate having microstructure, makes it possible to continue the treatment as the raw material concentration is kept constantly.

Further, according to the present invention, the raw material is in a solution state but not in a solid state, so it does not clog filters. Thus, in the case of the present invention, maintenance of the high-pressure treatment apparatus is easy.

### BRIEF DESCRIPTION OF DRAWING

FIG. 1 is a diagram illustrating supercritical treatment apparatus relating to the present invention.

### DESCRIPTION OF NUMERALS

1 Raw material vessel
2 Liquid pump
3 Check valve
4 High-pressure vessel
5 Drain valve
6 Treatment tank or Reaction tank
7 Substrate
8 Locally heating device

### BEST MODE FOR CARRYING OUT THE INVENTION

To begin with, an organic raw material in a solid state at room temperature and under normal pressure is introduced into a fluid kept in a supercritical state according to the present invention. Examples of a substrate usable as the supercritical fluid in the present invention include carbon dioxide, fluorinated compounds and water. Embodiments of the invention are illustrated below by taking the case of using supercritical carbon dioxide as an example.

The term “supercritical carbon dioxide” refers to carbon dioxide in a supercritical state beyond the critical point of 31.1° C., 7.38 MPa.

In the invention, a solution is first prepared by dissolving, in a fluorinated compound, an organic raw material in a solid state at room temperature and under normal pressure. As far as the organic raw material contains a fluorine atom, the raw material usually dissolves easily in a fluorinated compound. Therefore, when the reaction product to be coated on a substrate is a reaction product formable by use of a fluorine-containing organic substance as a starting raw material, a fluorinated compound solution can be easily prepared by use of the raw material.

In addition, when a particulate solid reaction product intended to be obtained is a reaction product formable by use of a fluorine-containing organic substance as a starting raw material, a fluorinated compound solution can be prepared with ease by use of the raw material. Even when the organic raw material in a solid state at room temperature and under normal pressure is an organic substance containing no fluorine atom, on the other hand, a fluorinated compound solution thereof can be prepared by selecting an appropriate fluorocarbon compound. More specifically, since it is known that a solute and a solvent which are akin in polarity generally have a good affinity for each other, a fluorocarbon compound solution can be prepared even from the fluorine-free organic substance as an organic raw material in a solid state by selecting a fluorocarbon compound close in polarity to the organic substance.

The term “a fluorinated compound” as used in the present invention is intended to include (1) a compound produced by substituting a fluorine atom or fluorine atoms for a hydrogen atom or hydrogen atoms of a saturated aliphatic hydrocarbon compound or for a chlorine atom or chlorine atoms of a saturated aliphatic chlorinated hydrocarbon, (2) a fluorinated saturated aliphatic alcohol (a compound produced by substituting a fluorine atom or fluorine atoms for a hydrogen atom or hydrogen atoms of the saturated aliphatic hydrocarbon moiety of the saturated aliphatic alcohol), (3) a fluorinated ether, (4) a fluorinated aromatic hydrocarbon, and (5) a fluorinated solvent.

The compound (1) produced by substituting a fluorine atom or fluorine atoms for a hydrocarbon or hydrogen atoms of the saturated aliphatic hydrocarbon compound or for a chlorine atom or chlorine atoms of the saturated aliphatic chlorinated hydrocarbon is represented by CₙH₂ₙ₊₂₋ₘFₘ or CₙH₂ₙ₊₂₋ₘ₋ₒClₒFₘ (wherein n is an integer of from 3 to 10, m and o each are an integer equal to or smaller than n). The carbon number n is preferably an integer of 3 to 10, more preferably an integer of 3 to 6.

Of these compounds, the compounds obtained by substitution of fluorine atoms for all the hydrogen atoms are preferred from the viewpoint of stability. Specifically, inert liquids generically called Fluorinert (trademark) can be given as aliphatic hydrocarbons, such as n-C₆F₁₄, C₅H₂F₁₀, C₃HF₅Cl₂, C₆HF₁₃, C₃H₅F₉, 1,1,1,3,3-pentafluorobutane (365 mfc), 1,1,1,2,2,4,4-heptafluorobutane (347 mcf) (C₄F₉CH═CH₂), 1H-perfluorohexane, n-perfluorohexane (PF 5060), 1,1,1,2,3,4,4,5,5,5-decafluoropentane (43-10 mee), and perfluoro(methylmorpholine) (PF 5052).

The fluorinated saturated aliphatic alcohol (2) (a compound produced by substituting a fluorine atom or fluorine atoms for a hydrogen atom or hydrogen atoms of the saturated aliphatic hydrocarbon moiety of the saturated aliphatic alcohol) is a compound represented by R_{f}—(CH₂)ₙ—OH or R_{f}—OH. In these formulae, R_{f} is a group represented by F(CF₂)ₙ, (CF₃)CF(CF₂)ₙ₋₂, H(CF₂)ₙ or the like, and n is an integer of 1 to 10 (wherein an even number predominates). Examples of such alcohol include tridecafluorooctanol (C₆F₁₃CH₂CH₂OH), 2,2,2-trifluoroethanol, 2,2-difluoroethanol, 2-monofluoroethanol, 2,2,3,3-tetrafluoropropanol, 2,2,3,3,3-pentafluoropropanol, 1,1,1,3,3,3-hexafluoro-2-propanol, 3,3,4,4,4-pentafluorobutanol, 2,2,3,3,4,4,4-heptafluorobutanol, 3,3,4,4-tetrafluoro-2-butanol, 3,3,4,4-tetrafluoro-2-methyl-2-butanol, 2,2,3,3,4,4,5,5-octafluoropentanol, 2,2,3,3,4,4,5,5,5-nonafluoropentanol, 3,3,4,4,5,5,6,6-octafluoro-2-hexanol, 3,3,4,4,5,5,6,6-octafluoro-2-methyl-2-hexanol, 3,3,4,4,5,6,6,6-octafluoro-5-trifluoromethylhexanol, 3,3,4,4,5,5,6,6,6-nonafluorohexanol, 2,2,3,3,4,4,5,5,6,6,6-undecafluorohexanol, 2,2,3,3,4,4,5,5,6,6,7,7-dodecafluoroheptanol, 3,3,4,4,5,5,6,6,7,7,8,8-dodecafluoro-2-octanol, 3,3,4,4,5,5,6,6,7,7,8,8-dodecafluoro-2-methyl-2-octanol, 3,3,4,4,5,5,6,6,7,8,8,8-dodecafluoro-7-trifluoromethyloctanol, 2,2,3,3,4,4,5,5,6,6,7,7,8,8,9,9-hexadecafluorononanol, 3,3,4,4,5,5,6,6,7,7,8,8,9,10,10,10-hexadecafluoro-9-trifluoromethyldecanol, and 3,3,4,4,5,5,6,6,7,7,8,8,9,9,10,10,10-heptadecafluorodecanol.

The fluorinated ether (3) is a compound represented by R_{f}—O—R_{f}, R_{f}—O-Me, R_{f}—CH₂—O-Me, R_{f}—O-Et, R_{f}—CH₂—O-Et or the like. Herein, R_{f} is a group represented by F(CF₂)ₙ, F(CF₂)ₙCHF, F(CF₂)ₙCH₂, H(CF₂)ₙ or the like, and n is an integer of 1 to 10 (wherein an even number predominates).

The fluorinated aromatic hydrocarbon (4) includes perfluorobenzene, 2,2-bis(4-hydroxyphenyl)hexafluoropropane, and so on.

Incidentally, the substances (1) to (4) are known substances. Chemicals appropriately purchased as required can be utilized for them.

The fluorinated solvent (5) includes perfluoro(2-butyltetrahydrofuran), perfluoro(tributylamine), Aflute (trade name of hexafluoroacetone, a product of Daikin Industries, Ltd.), ASAHIKLIN (trade name of hexafluoroacetone, a product of Asahi Glass Co., Ltd.), and so on.

When a solid raw material is made into a solution by dissolution in a fluorinated compound, it becomes possible to feed the raw material solution directly into a supercritical fluid in a highly pressurized state by means of a liquid pump. In addition, when the state of the raw material to be fed is a solution, it is also possible to spray the solution into the supercritical fluid, and thereby to increase the surface area and effect immediate dissolution of the raw material solid substance in the supercritical fluid. By controlling the concentration of the solution and the liquid feed speed of the liquid pump, an exact amount of the raw material can be introduced into a vessel. The feeding in a solution form does not cause trouble of clogging filters.

Additionally, the fluorinated compounds are exceedingly stable compounds, and many of them are known to have neither flammability nor ignitability. As to toxicity also, the fluorinated compounds are by far lower in toxicity than general organic solvents, so they are safe solvents. As mentioned above, the use of the fluorinated compounds as solvents makes it possible to continuously feed a solid organic raw material into a supercritical fluid with efficiency and in safety.

In the case of treatment with a high-pressure fluid, such as supercritical treatment, in particular, effects equivalent to or better than those attained by treatment under a normal pressure or reduced pressure condition can be generally achieved at markedly low temperatures as compared with those adopted in treatment under a normal pressure or reduced pressure condition, and a self-decomposition problem of fluorocarbon compounds hardly occurs. In other words, the Inventor found that the fluorinated compounds are most suitable solvents for use in performing supercritical treatment to which low-temperature treatment is permitted, and thereby have achieved the present invention.

In the method of the present invention, the usage ratio between the foregoing carbon dioxide (the supercritical fluid) and the fluorinated compound, though not particularly limited, is preferably from 10:1 to 1:10 by volume.

When the total amount of these supercritical fluid and fluorinated compound is taken as 100%, the concentration of the organic substance to be dissolved therein, though it differs depending on the treatment to be intended or the reaction to be caused and has no particular limits, is generally 0.01 mass % or above, preferably from 0.05 mass % or above, more preferably from0.1 to 5 mass %, in the case of the micro-granulation.

In the present invention, the treatment, the reaction and so on are performed under high-pressure conditions, and the temperature and pressure conditions in the high-pressure vessel and the introduction amount of a fluorinated compound solution of raw material are determined according to a mode of the raw material organic substance dissolved in the fluorinated compound.

More specifically, when the supercritical treatment is carried out through reaction of the raw material organic substance in the high-pressure vessel, the temperature and pressure conditions are adjusted to suit the reaction.

In another case where a fluid in a state that a raw material organic substance is dissolved in a supercritical fluid (hereinafter referred to as “a raw-material-dissolved fluid”) is prepared in a high-pressure vessel, this raw-material-dissolved fluid is introduced into a separate and distinct reaction vessel, and supercritical treatment of the fluid is carried out in this reaction vessel, the conditions, under which the highest solubility of the raw material in the presence of the fluorinated compound is attainable, are chosen.

Additionally, whether the supercritical fluid, into which the fluorinated compound is introduced, becomes a one-phase supercritical state or a two-phase state having separate liquid phases of fluorinated compound is determined depending on the temperature, the pressure and the volume in the high-pressure vessel, and the introduction amount of the fluorinated compound solution of raw material.

Since the density of the fluorinated compound is generally of the order of 1.5 and greater than that of other solvents, the fluorinated compound in a liquid phase is in a state of being accumulated at the bottom of the high-pressure vessel when no agitation is carried out in the high-pressure vessel and the two-phase state arises.

Therefore, control of the high-pressure vessel conditions makes it possible to separate only the fluorinated compound in the liquid phase, as the organic substance concentration in the supercritical phase is kept constant, and to take it out from the high-pressure vessel, and the fluorinated compound taken out can also be recycled.

According to the present invention, as mentioned above, it becomes possible to replenish the supercritical fluid with the raw material organic substance while holding the raw material in a highly pressurized state, which have so far been a problem, the raw material can be fed on the spot without preparing the raw material for every experiment, there is no fear of clogging filters, and it becomes possible to introduce a large quantity of raw material into the supercritical fluid in a shorter time than before.

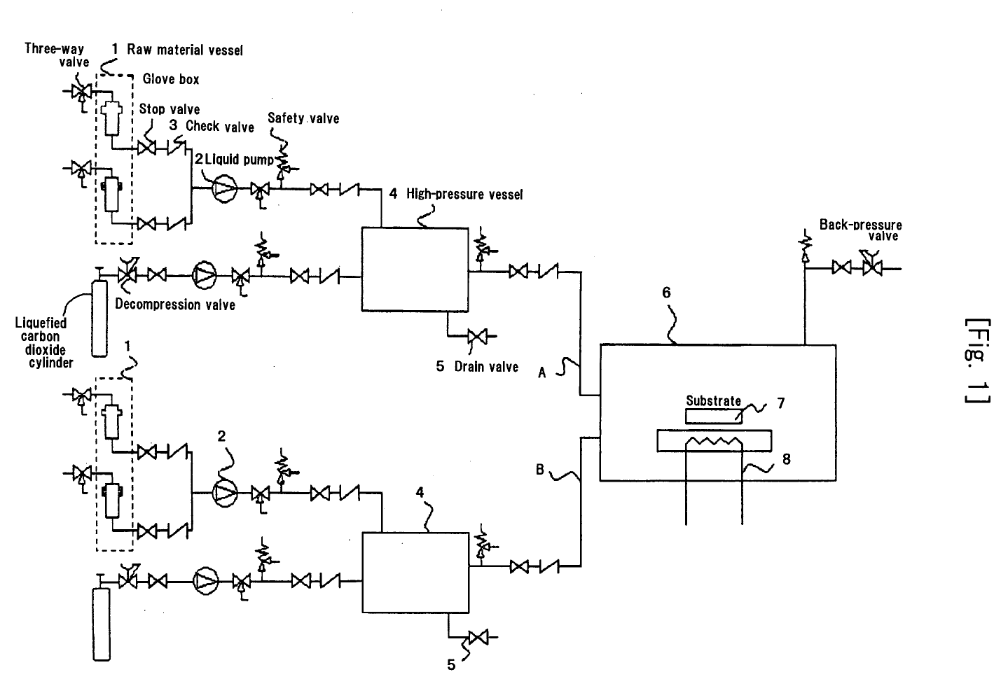

In the next place, an embodiment of a supercritical treatment apparatus is the present invention is illustrated according to FIG. 1.

A fluorinated compound solution in which an organic raw material is dissolved at room temperature and under normal pressure (hereinafter referred to as “a fluorocarbon-compound solution raw material”) can be easily stored in a raw material vessel 1 at room temperature and under normal pressure, and hermetically sealed therein. The fluorocarbon-compound solution stored in the sealed raw material vessel can be pressure-sent to a liquid pump 2 by a slight positive pressure of the order of 50 kPa produced through introduction of high-purity nitrogen, and continuous feeding into the liquid pump 2 becomes possible. The liquid pump 2 can raise the pressure of the fluorocarbon-compound solution of raw material and make the solution a highly pressurized state with ease and in safety, so the fluorocarbon-compound solution of raw material can be fed continuously into a high-pressure vessel held in a high-pressure condition with efficiency and in safety.

Incidentally, an O-ring seal mechanism is adopted as the mechanism for sealing the raw material vessel, and Teflon (registered trademark) is used as a material for the O-ring. The adoption of the O-ring makes it possible to use glass for the raw material vessel and permits observation of the amount of a remaining raw material. It becomes also possible to use Teflon (registered trademark) for the raw material vessel by the adoption of the O-ring, and a raw material subject to corrosion or decomposition can be stored in the raw material vessel for a long time. The use of the O-ring makes it possible to change the raw material into the raw material vessel by more convenient, more efficient and lower-cost operations than the seal mechanism using a metal gasket. On the other hand, although an O-ring made from Viton is generally used as the O-ring for such a seal mechanism, fluorine-containing rubber like Viton swells in a fluorinated compound like Fluorinert (trademark) to result in not only reduction in its useful like but also insufficiency of its sealing effect, and, what's worse, to produce ill effects, such as a rupture of a glass-made raw material vessel, in some cases. Such a phenomenon is also observed in other fluorine-containing rubbers superior in corrosion resistance, such as KALREZ (trade name). In order to avoid these problems, an O-ring made form Pure Teflon (registered trademark) is used as the O-ring used for the raw material vessel in the invention. The O-ring made from Teflon (registered trademark) can be purchased, e.g., from K.K. Universal. Although the O-ring made from Teflon (registered trademark) slightly swells in a fluorinated compound, its swelling degree is minute, and it not only can be used for a long time, it also can retain sufficient sealing action even on a raw material having corrosiveness or susceptibility to decomposition.

Additionally, preparation of the raw material fluorinated-compound at room temperature and under normal pressure, and storage of the raw material fluorinated-compound in the raw material vessel, depending on the reactivity of the organic raw material dissolved therein, are preferably carried out in a glove box. In other words, the raw material vessel 1 is preferably placed in a sealed glove box in which the atmosphere is replaced with an inert gas. Although the liquid pump generally has a check mechanism including a check valve 3 as shown in the figure, it is preferred for greater safety that both an open/shut valve for starting and stopping the feed of the fluorinated-compound solution of raw material into the liquid pump and a check valve for preventing backflow of the fluorinated-compound solution of raw material are installed in a channel between the raw material vessel and the liquid pump.

A method of introducing the raw material into a high-pressure vessel 4 can also be devised. Specifically, provision of a mechanism to spray the raw material solution to be introduced into the high-pressure vessel into the supercritical fluid via nozzles makes it possible to dissolve the organic raw material in a much greater amount, at much higher speed than in a state of solid fine particles, because the raw material dispersed in the liquid is in a state of clusters having much smaller volume than the particulate raw material in a solid state. In addition, provision of an agitation mechanism makes it possible to dissolve a slight amount of raw material remaining in the liquid phase in the supercritical fluid by subsequent mechanical agitation.

Further, a drain 5 may be provided underneath the high-pressure vessel 4 via a high-pressure valve. By the drain 5, only the liquid phase of the fluorinated compound in a two-phase state is recovered from the high-pressure vessel, and the recovered fluorinated compound can be reused in preparing a fluorinated-compound solution of raw material by dissolving the organic raw material therein again.

In the FIG. 1, “6” stand for a supercritical treatment tank or a reaction tank, and shows a mode in which a coating is formed on a substrate 7. “8” stands for a locally heating device. The supercritical solution fluid containing the organic raw material for treatment is introduced into the supercritical treatment tank or the reaction tank 6 through at least either of two feeding lines A and b, and used for formation of a thin film of the intended substance on a substrate 7 through reaction or without reaction.

For operations in the case of forming fine particles by using an organic substance dissolved in a fluorinated compound as raw material, a collection vessel for collecting the fine particles is placed instead of the substrate to be coated with a thin film in the foregoing mode. Further, at the start of reaction of the organic substance as raw material with a reactant, the density of supercritical carbon dioxide is lowered sharply by a steep increase in temperature under a condition that the pressure in the reaction vessel is controlled to a predetermined level by means of a back-pressure valve, and thereby a supersaturated state is created and nucleation of the fine particles is promoted to result in growth of the fine particles. And the grown particles are collected in the collection vessel. In another manner, the density of supercritical carbon dioxide is lowered sharply at the start of reaction between the organic raw material and a reactant through a steep reduction of the internal pressure in the reaction vessel by means of the back-pressure valve under a condition that the temperature is kept constant, and thereby a supersaturated state is created and nucleation of the fine particles is promoted to result in growth of the fine particles. And the growth particles are collected in the collection vessel. In still another manner, the coating of a thin film or the formation of fine particles may be performed, as the pressure in the high-pressure vessel is kept at a fixed value by continuously ejecting a raw material solution fluid from nozzles, which are connected to the high-pressure vessel and have conductance kept constant, while consistently feeding the raw material solution fluid onto the substrate or into the collection vessel by means of a pump.

Incidentally, the high-pressure vessel 6 requires periodic opening and closing of its lid for putting in the substrate or the collection vessel, and a metal gasket, a metal O-ring, or a Teflon (trademark) O-ring is used as a mechanism to seal the lid. This is because the supercritical solution fluid, which is prepared by introducing a fluorinated compound into a supercritical fluid, has stronger swelling action of rubber O-rings than the fluorinated compound by itself. Therefore, the O-rings made from nitrile rubber, such as Buna-N rubber, can be used in the case of treatment of usual supercritical CO₂, but it is required to use a metal gasket, a metal O-ring, or a Teflon (trademark) O-ring which all have resistance to high-pressure fluorinated compounds as well as high-pressure supercritical fluids when the fluorinated compounds according to the present invention are used.

### EXAMPLE

### Formation of Thin Zr Oxide Film on Silicon Substrate

In a glove box having undergone replacement of the atmosphere with an inert gas, when an organic raw material Zr(HFA)₄ (HFA: hexafluoroacetylacetonate) weighed in at 1 g was put in a flask beaker and 100 ml of fluorinated compound, ASAHIKLIN AK225 produced by Asahi Glass Co., Ltd., in a liquid state at room temperature and under normal pressure was further poured into the flask beaker, a saturated solution in which most of the Zr(HFA)₄ was dissolved and a trace of Zr(HFA)₄ remained was prepared. Zr(HFA)₄ is a organic metal containing fluorine atoms, and it not only is used as raw material of Zr metal and compounds containing Zr element, but also functions as a homogenous catalyst. In general, as mentioned above, fluorine-containing organic metals can be dissolved in fluorocarbon compounds in a liquid state at room temperature and under normal pressure, and they can be used as organic raw materials or catalysts for use in the present invention.

A film was formed from the thus-prepared raw material fluorinated-compound in the following manner according to an apparatus as shown in FIG. 1. To begin with, 80 mL of the fluorinated-compound solution was poured into a raw material vessel 1 having 200 ml capacity in the atmosphere of nitrogen gas, which was constructed from quartz and SUS-made jigs and placed in a gas-substitutable glove box installed as an attachment in the apparatus developed by the present invention, and then hermetically sealed in the vessel. The raw material vessel was designed so that an introduction inlet of nitrogen gas was provided on the upper side of the vessel via a valve and an outlet for discharge of a raw material solution was provided on the lower side of the vessel via a valve, and the solution was pressure-sent into a liquid introduction inlet of a liquid pump by nitrogen gas of 0.05 MPa in pressure introduced on the upper side of the vessel. The fluorinated-compound solution introduced into a liquid pump 2 received a pressure increase to 17 MPa or higher as the flow rate thereof was controlled to 5 ml/min by the liquid pump 2, and was introduced eventually into a reaction tank 6 controlled to the pressure of 17 MPa and a temperature of 80° C. or below.

On the other hand, H₂O was used as a reactant.

A solid product ZrO₂ insoluble in a fluorinated compound can be produced by the following reaction scheme between Zr(HFA)₄ and H₂O:
Zr(HFA)₄+2H₂O→ZrO₂+4H(HFA)

The reactant H₂O hardly dissolves in ASAHIKLIN, so liquefied carbon dioxide was used as solvent for dissolving the reactant H₂O. Although the H₂O hardly dissolves in the liquefied carbon dioxide also as compared with polar solvents, such as alcohol, the percentage of dissolution of H₂O in liquefied carbon dioxide is 0.01% according to ENCYCLOPEDIA CHIMICA, and it is much higher than that in the ASAHIKLIN AK225.

The reactant H₂O was poured into a high-pressure raw material vessel 4, which was different from the vessel into which the fluorinated compound was poured, all made of SUS and 200 ml in volume, and then hermetically sealed in the raw material vessel 4. Then, the reactant H₂O was mixed with the liquefied carbon dioxide poured into the high-pressure raw material vessel, which was taken out from a cylinder equipped with a siphon tube by open/shut operations of valves. The interior of the high-pressure raw material vessel 4 had a mechanism to make the H₂O bubble by use of the poured-in liquefied carbon dioxide, and further was designed to adequately mix the H₂O and the liquefied carbon dioxide through an agitation mechanism to dissolve the saturation amount of the H₂O in the liquefied carbon dioxide. Incidentally, in this example, the agitation speed was adjusted to 500 rpm or above. The liquefied carbon dioxide in which the H₂O was fully dissolved was connected to a suction side of a pressurization pump (a reciprocating motion compressor MGS-C-250SEP, trade name, made by Alps Hanbai K. K.) by the cylinder pressure, received further raise in pressure by the pressurization pump, and introduced into a reaction tank 6.

The reaction tank 6 was equipped with a locally heating device 8 as shown in the figure, and designed to deposit solid products on the substrate 7 installed therein and collect the products. In the present experimental apparatus, it is possible to adjust the temperature to 300° C. or above only in the vicinity of the substrate as the reaction tank wall was maintained at a temperature of 40° C. to 80° C.

Herein, the substrate to be used was a 4-inch Si substrate. The fluorinated-compound solution of raw material was diluted with a supercritical carbon dioxide and fed onto the substrate, and, at the same time, a solution fluid obtained by dissolving H₂O in liquefied carbon dioxide was compressed and overheated, and fed as a supercritical fluid onto the substrate, thereby causing reaction. After restoring the interior of the reaction tank to room temperature and normal pressure, the Si substrate was taken out. By measurement with a spectroscopic film-thickness meter, a deposit of solid products was found to be 15 nm, which thickness is equivalent to that of SiO₂ film.

It was recognized that the deposit having an even surface, though a minuscule number of fine particles having particle diameters of the order of up to 100 nm were present thereon, was accumulated.

Further, when the surface composition of the solid product-accumulated substrate was analyzed in accordance with X-ray photoelectron spectroscopy after removal of contaminants on the surface by cleaning with an organic solvent, clear zirconium-element peaks and oxygen-element peaks were observed, though residual fluorine was also observed on the surface, and thereby it was ascertained that ZrO₂ was produced by the reaction according to the aforesaid reaction scheme.

Thereafter, isolation of the fluorinated compound from the liquefied carbon dioxide was further carried out, and the fluorinated compound was recovered at room temperature and under normal pressure, and furthermore the fluorocarbon compound was evaporated at room temperature. Thus, it was possible to recover a solid organic substance thought to be the raw material Zr(HFA)₄.

As apparent to the persons skilled in the art, the reactions applicable in the present invention go beyond hydrolysis reaction as shown in the above Example. More specifically, when hydrogen is used as the reactant, it is possible to produce reduced substances of organic metals in accordance with the invention. In addition, it is also possible to produce oxides from organic metals by using oxygen or ozone as the reactant. Further, it is possible to obtain reaction products by amination, nitration and so on in a thin-film state or a particulate state by selections of the organic raw materials and the reactants, and adjustment of the reaction conditions in the supercritical state.

### EXAMPLE 2

### Formation of Thin Lanthanum Oxide Film on Silicon Substrate

In a glove box having undergone replacement of the atmosphere with an inert gas, when about 0.5 g of an organic raw material La(EtCp)₃ (EtCp: ethylcyclopentadiene) was put in a flask beaker and 100 ml of ASAHIKLIN AK225, a product of Asahi Glass Co., Ltd., in a liquid state at room temperature and under normal pressure was further poured into the flask beaker, a quantity of La(EtCp)₃ was precipitated. Thus, the solubility of La(EtCp)₃ proved considerably lower than that of Zr(HFA)₄, but the liquid that was colorless and transparent before it was poured became whitish and cloudy, and a saturated solution of La(EtCp)₃ was obtained. La(EtCp)₃ is an organic metal containing no fluorine atom, and it not only is used as raw material of La metal and compounds containing La element but also functions as a homogenous catalyst.

In addition, cyclopentadiene (Cp) itself forms organic metals in combination with many metals, and they are also known as important compounds as catalysts. Even fluorine-free organic metals like those compounds can be dissolved in fluorocarbon compounds in a liquid state at room temperature and under normal pressure by selection of solvents, and can be used as the organic raw materials or the catalysts used in the present invention.

By use of the apparatus as shown in FIG. 1, 70 mL of the obtained fluorinated-compound solution was poured into the raw material vessel having 200 ml capacity in the atmosphere of nitrogen gas, which was constructed from quartz and SUS-made jigs and placed in the gas-substitutable glove box, as mentioned above, and then hermetically sealed in the vessel. The fluorocarbon-compound solution introduced into the liquid pump received a pressure increase to 17 MPa or higher as the flow rate thereof was controlled to 5 ml/min by the liquid pump, and was introduced eventually into the reaction tank controlled to the pressure of 17 MPa and a temperature of 80° C. or below.

On the other hand, H₂O was used again as a reactant.

A solid product La₂O₃ insoluble in a fluorinated compound solvent can be produced by the following reaction scheme between La(EtCp)₃ and H₂O:
2La(EtCp)₃+3H₂O→La₂O₃+3H(EtCp)

The reactant H₂O was poured into the high-pressure raw material vessel, which was different from the vessel into which ASAHIKLIN AK225 was poured, all made of SUS and 200 ml in volume, and them hermetically sealed in the raw material vessel. And then the reactant H₂O was mixed with the liquefied carbon dioxide poured into the high-pressure raw material vessel, which was taken out from a cylinder equipped with a siphon tube by open/shut operations of valves. Incidentally, agitation was carried out at an agitation speed of 500 rpm or above in this example. The liquefied carbon dioxide in which H₂O was fully dissolved was linked to the suction side of a pressurization pump (a reciprocating motion compressor MGS-C-250SEP, trade name, made by Alps Hanbai K. K.) by the cylinder pressure, received a further raise in pressure by the pressurization pump, and introduced into the reaction tank.

In this example, the temperature was adjusted to 300° C. or above only in the vicinity of the substrate and the pressure was adjusted to 17 MPa or above, as the reaction tank wall was maintained at a temperature of 40° C. to 80° C. Under these conditions, it is thought that the fluorinated compound-carbon dioxide mixture solution fluid is in a mixed supercritical state. As the substrate, a 4-inch Si substrate was used. The fluorinated-compound solution was diluted with supercritical carbon dioxide and fed onto the substrate, and, at the same time, a solution fluid obtained by dissolving H₂O in liquefied carbon dioxide was compressed and overheated, and fed as a supercritical fluid onto the substrate, thereby causing reaction. After restoring the interior of the reaction tank to room temperature and normal pressure, the Si substrate was taken out. A deposit of solid product was found thereon.

When the surface composition of the solid product-accumulated substrate was analyzed in accordance with X-ray photoelectron spectroscopy after removal of contaminants on the surface by cleaning with an organic solvent, a clear lanthanum element spectrum and oxygen peaks identical to those of lanthanum oxide were observed, though residual fluorine was also observed on the surface. In other words, it was ascertained that La₂O₃ was produced by the reaction according to the aforesaid reaction scheme.

### EXAMPLE 3

### Making of Fine Particles of Zirconium, Lanthanum Oxides

The same zirconium material and lanthanum material as used in Examples 1 and 2 were simultaneously introduced into the reaction tank, and allowed to react with H₂O-dissolved liquefied carbon dioxide in the vicinity of a heater for local heating. As a result thereof, fine particles were separated out. The particle diameter and composition of the separated fine particles were evaluated by use of a scanning electron microscope, a transmission electron microscope and an energy-dispersive X-ray analysis. Fine particles having particle diameters within a range from several tens nm to several hundreds nm were obtained, and the result of compositional analysis by the energy-dispersive X-ray analysis revealed that these fine particles were fine particles of zirconium oxide and fine particles of an oxide containing both zirconium and lanthanum. By using the present invention in this way, fine particles measuring several tens nm to several hundreds nm in diameter can be obtained.

### EXAMPLE 4

### Formation of Thin Copper Film on Silicon Substrate

In a glove box having undergone replacement of the atmosphere with an inert gas, when 20 ml of ASAHIKLIN AK225, produced by Asahi Glass Co., Ltd., in a liquid state at room temperature and under normal pressure was poured into 1 g of an organic raw material Cu(HFA)₂ (HFA: hexafluoroacetylacetonate) placed in a Teflon (trademark) vessel, all the organic raw material was found in a dissolved state. The obtained fluorinated-compound solution was loaded into a 200-μl syringe and dripped into a high-pressure vessel having internal capacity of about 40 ml. A stage for heating with a heater was mounted on a lid of the high-pressure vessel having a mechanism to seal high pressure with a SUS-made gasket, and was placed a silicon substrate on this stage. The lid of the high-pressure vessel was shut in the glove box, and the lid-shut vessel was placed in a furnace. The high-pressure vessel was filled with 0.4 MPa of hydrogen, then charged with CO₂, and controlled so as finally to have a vessel pressure of 17 MPa, a vessel temperature of about 200° C. and a stage temperature of 265° C., and a thin film was deposited under these conditions. When the obtained thin film was evaluated by X-ray photoelectron spectroscopy, the peaks of Cu was observed, and further this film exhibited electric conductivity, so it proved a thin Cu film.

More specifically, a solid product Cu insoluble in a fluorinated compound solvent can be prepared from Cu(HFA)₂ soluble in the fluorinated compound solvent in accordance with the following reaction scheme:
Cu(HFA)₂+H₂→Cu+2H(HFA)

1. A supercritical treatment method, comprising: dissolving an organometallic compound, in a fluorinated compound in a liquid state at room temperature under normal pressure, to prepare a solution; and introducing the solution into a supercritical fluid, to treat a substrate under a supercritical condition.

2. A supercritical treatment method, comprising: dissolving an organic raw material in a solid state at room temperature under normal pressure, in a fluorinated compound in a liquid state at room temperature under normal pressure, to prepare a solution; and introducing the solution and a reactant capable of reacting with the organic raw material but incapable of reacting with the fluorinated compound into a supercritical fluid, to allow to react with each other under a supercritical condition, and thereby to form a coating of a reaction product on a substrate.

3. A supercritical treatment method, comprising: dissolving an organic raw material in a solid state at room temperature under normal pressure, in a fluorinated compound in a liquid state at room temperature under normal pressure, to prepare a solution; and introducing the solution and a reactant capable of reacting with the organic raw material but incapable of reacting with the fluorinated compound into a supercritical fluid, to allow to react with each other under a supercritical condition, and thereby to make solid fine particles of a reaction product.

4. The supercritical treatment method as claimed in any one of claims 1 to 3, wherein the supercritical fluid is supercritical carbon dioxide.

5. A supercritical treatment apparatus, comprising: a sealable raw-material vessel into which a solution containing at least one organic raw material dissolved in a fluorinated compound is introduced under atmospheric pressure, a high-pressure vessel in which a supercritical fluid is stored, a liquid pump for pressurizing the solution and introducing the pressurized solution into the high-pressure vessel, and a mechanism for pressure-sending the solution from the sealable raw-material vessel into the solution-feeding pump, whereby allowing to cause reaction of the organic raw material in a supercritical condition inside the high-pressure vessel or a reaction tank, to form a coating of a reaction product on a substrate, wherein an O-ring made form Teflon (registered trademark) is used for the raw material vessel, and a metal gasket or a metal O-ring or an O-ring made from Teflon (registered trademark) is used for the high-pressure vessel.

6. A supercritical treatment apparatus, comprising: a sealable raw-material vessel into which a solution containing at least one organic raw material dissolved in a fluorinated compound is introduced under atmospheric pressure, a high-pressure vessel in which a supercritical fluid is stored, a liquid pump for pressurizing the solution and introducing the pressurized solution from the sealable raw-material vessel into the solution-feeding pump, whereby allowing to cause reaction of the organic raw material in a supercritical condition inside the high-pressure vessel or a reaction tank, to make solid fine particles of a reaction product, wherein an O-ring made from Teflon (registered trademark) is used for the raw material vessel, and a metal gasket or a metal O-ring or an O-ring made from Teflon (registered trademark) is used for the high-pressure vessel.

7. The supercritical treatment apparatus as claimed in claim 5 or 6, wherein the supercritical fluid is supercritical carbon dioxide.
